(19) United States
(12) Patent Application Publication
(10) Pub. No.: US 2004/0235650 A1
(43) Pub. Date: Nov. 25, 2004

(54) Method for making supported metallic nanoparticles on fluidised bed

(76) Inventors: Khashayar Saleh, Compiegne (FR); Florence Cordier, Siouville-hague (FR); Daniel Steinmetz, Toulouse (FR); Mehrdji Hemati, Toulouse (FR); Silvia Gomez Gallardo, Em Delft (NL); Bruno Chaudret, Vigoulet Azil (FR); Karine Philippot, Montbrun Lauragais (FR)

Correspondence Address: BROWDY AND NEIMARK, P.L.L.C., 624 NINTH STREET, NW, SUITE 300, WASHINGTON, DC, 20001-5303, US

(21) Appl. No.: 10/479,282

(22) PCT Filed: May 28, 2002
(86) PCT No.: PCT/FR02/01795

(30) Foreign Application Priority Data
May 30, 2001 (FR) 01/07020

(51) Int. Cl. B01J 21/14

(52) U.S. Cl. 502/258

(57) ABSTRACT

The invention concerns a method for preparing supported nanoparticles comprising the following steps: introducing in an adequate solvent a metallic co-ordination complex capable of being decomposed at a temperature less than 200° C, optionally in the presence of a gas reactive under reactive gas pressure less than 3 bars; spraying the resulting preparation in conditions avoiding its decomposition in a fluidised bed containing suspended porous support grains, then breaking down the metallic co-ordination complex optionally in the presence of a reactive gas.

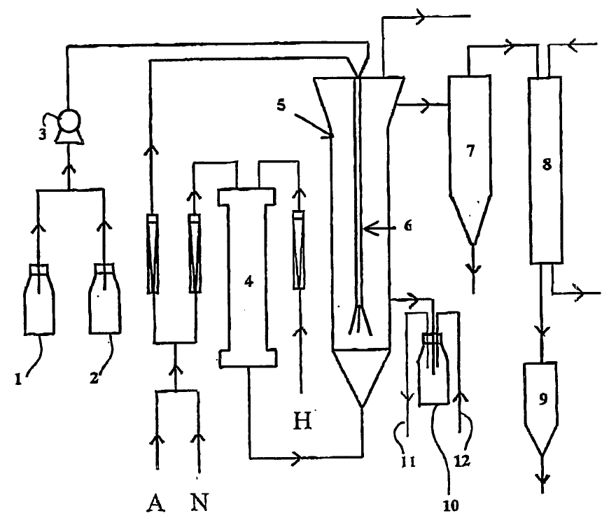

The present invention concerns a method for making metallic nanoparticles supported in porous support grains in a fluidized bed at low temperature. These metallic nanoparticles can find applications in different fields such as catalysis, microelectronics, . . . .

Supported catalysts constituted by metallic nanoparticles fixed on a support are generally prepared by the depositing a metallic salt or a precursor coordination complex (or a mixture of precursors) on the support, followed by a step of activation consisting of thermal treatments performed in air and/or in hydrogen. These methods require several successive steps:

(1) impregnation of the porous support with an inorganic or organometallic coordination complex;

(2) evaporation of the solvent;

(3) thermal decomposition of the complex fixed on the porous support;

(4) reduction or oxidation at elevated temperature.

These conventional methods for preparation of supported metallic catalysts imply thermal treatments at generally elevated temperatures. One then obtains masses of metallic particles the size of which can be relatively large and vary over a large range. In addition, the dispersion of the metallic particles on the porous support grains is often mediocre and non-homogenous. Now, from a point of view of catalytic applications, it is established that the effectiveness of the supported catalyst is greater when the size and the dispersion of the metallic particles that constitute it are respectively reduced and increased. In addition, these conventional impregnation methods are difficult to place in operation and relatively costly, given that they imply several successive operations that often require drastic temperature and pressure conditions and are carried out in different apparatuses. Finally, the major drawback of these usual methods is that they can be difficult to reproduce in particular insofar as concerns the size and the surface state of the metallic particles, which are difficult to control, because of the necessity for an activation step, performed for example by calcination.

An impregnation of a support by conventional impregnation and calcination is disclosed in the patent U.S. Pat. No. 4,945,079. In this document, alumina is utilized as the support for the preparation of catalysts based on Ni/Mo activated by hydrodenitrogenation (HDN). These catalysts have been prepared by successive steps (impregnation, drying) followed by calcination at 120 to 400° C.

Other impregnations achieved by methods of the same type are disclosed by the documents U.S. Pat. No. 5,200,382, U.S. Pat. No. 5,334,570, EP-0773062 and WO-99/08790.

An impregnation of a support by conventional impregnation starting from colloidal solutions is for example described in the document FR98.10347 in which the catalysts are constituted by nanoparticles of metallic oxides fixed on a support (silica, alumina, magnesia, . . . ).

A Chemical Vapor Deposition (CVD) coupled with a fluidized bed is described for example in the document WO-95/02453. This document discloses a preparation of supported catalysts constituted by grains of a porous support (SiO₂) on which are dispersed metallic particles of rhodium. This method uses a CVD technique in a fluidized bed: the organometallic precursors are volatilized in the presence of a reducing gas during their passage in the bed, then adsorbed on the support grains of the fluidized bed. Thermal decomposition of the adsorbed molecular species then permits the attainment of particles of nanoscopic size. Certainly, the operating temperature of the method is lower than 200° C., a temperature lower than the temperatures generally employed for the conventional impregnation methods. However, this method is limited by the choice of precursor which must be volatile and implies the creation of conditions permitting its activation.

The document U.S. Pat. No. 5,935,889 describes, regarding itself, the development of catalysts by coating support grains in a fluidized bed. This method consists in the repetition of two successive steps: vaporization of a precursor suspension, then drying. Thus, a layer of precursor of increasing thickness is formed at the surface of the grains. Different treatments then permit conversion of the precursor into the desired catalyst.

The present invention has for its goal to furnish a method that permits, in a single step, the preparation of supported metallic nanoparticles the size of which is smaller than those observed with the common methods. The size dispersion of the particles will preferably be narrower and the reproducibility will be, as regards it, greater than for the methods of the prior art.

One object of the invention is in particular to obtain in a reproducible manner particles of a monodispersed nanometric size, and a dispersion on the walls of the homogeneous support grains.

Another object is to permit the attainment of materials having controlled characteristics (size, surface state/chemical purity and dispersion of the deposited metallic particles, quantities deposited, preservation of the chemical properties of the support).

Another object is to furnish a method able to operate continuously in a more economical manner.

Another object is to improve the efficiency of the potential catalysts obtained with respect to a catalyst prepared by conventional impregnation and of which the amount of metal deposited is identical or to reduce the quantity of metal necessary for equal efficiency.

To this end, the invention provides a method for preparation of supported nanoparticles, characterized in that it has the following steps:

introduction into an adequate solvent of a metallic coordination complex able to be decomposed at a temperature below 200° C with the possible presence of a reactive gas at a reactive gas pressure lower than 3 bars,

spraying of the preparation thus obtained under conditions suitable to avoid its decomposition in a fluidized bed containing porous support grains placed in suspension by a gaseous current, then

decomposition of the metallic coordination complex in the possible presence of a reactive gas.

The solvent is preferably chosen in such a manner that the metallic coordination complex is soluble in this solvent. The decomposition temperature of the metallic coordination complex is, as regards it, advantageously below 80° C. The decomposition is achieved preferably at ambient temperature.

The metallic coordination complex presents a metal bond with any atom (sulfur, carbon, etc . . . ). However, this method is particularly well adapted to organometallic coordination complexes presenting a metal-carbon bond.

In one form of realization of the present invention, the spraying of the preparation at the interior of the fluidized bed is a pneumatic spraying carried out by a current of vector gas. In this case, the gas utilized for the pneumatic spraying is advantageously chosen from the group of neutral gases (nitrogen, argon . . . ). The method according to the invention also permits two metallic coordination complexes to be introduced at the start in a solvent to form a metallic alloy.

As a result, the metallic coordination complex will equally be called a precursor or a metallic precursor.

Thus, the method of the invention uses a technique of spraying in a fluidized bed and presents the following advantages:

use of the fluidized bed at a temperature close to ambient,

deposition of the metallic precursor by liquid means by spraying of a solution,

controlled evaporation of the solvent,

simultaneous or consecutive decomposition of the adsorbed precursor into metallic nanoparticles under low pressure of a reactive gas (1 to 3 bars), and at a temperature sufficiently low to avoid uncontrolled aggregation of the particles,

a perfectly regulatable rate of adsorbed metal as a function of the duration of the operation,

certain supported metallic nanoparticles produced by this method are found to be very active catalysts for hydrogenation of 1-hexene into hexane.

The method of the invention can be carried out continuously, possibly in the same apparatus (“one-pot method”). The metallic precursor is fixed on the grains of the support. It then undergoes a decomposition by the action of a reactive gas possibly aided thermally at moderate temperature leading to metallic particles that remain fixed on the grains, and organic compounds that are carried along in the current of vector gas. The temperature at which this decomposition is achieved avoids a weakening of the fixation bonds on the grains during the course of the decomposition and permits chemosorption of the metallic particles during the course of the decomposition and, consequently, reduces the risk of migration of metallic atoms leading to an aggregation of the particles.

The reactive gas is chosen for example from the group comprising hydrogen (H₂) and carbon monoxide (CO).

The metallic coordination complex can be chosen from the non-exhaustive group comprising:

tris(dibenzylideneacetone)diplatinum(0)

tris(dibenzylideneacetone)dipalladium(0)

bis(acetylacetonate)palladium(II)

bis(1,5-cyclooctadiene)nickel(0)

bis(acetylacetonate)nickel(II)

(1,3-cyclooctenyl)(1,5-cyclooctadiene)cobalt(I)

pentacarbonyl iron(0)

(1,5-cyclooctadiene)(1,3,5-cyclooctatriene)ruthenium(0)

(acetylacetonate) (1,5-cyclooctadiene)rhodium(I)

bis(methoxy)bis(1,5-cyclooctadiene)diiridium(I)

(cyclopentadienyl)(tertbutylisonitrile)copper(I)

bis(dimethylamidide)ditin(II)

chloro(tetrahydrothiophene)gold(I)

cyclopentadienyl indium(I).

Operation at moderate temperature is rendered possible essentially by the appropriate choice of precursor.

The method of the invention permits the attainment of metallic particles of nanometric size and more homogeneous dispersion. These results can be explained by the combination of the low temperatures utilized and the reduced pressure within the fluidized bed. In particular, a low temperature limits the migration of metallic atoms and thus their tendency to be aggregated, and consequently diminishes the size of the particles obtained.

The method of the invention being performed in a single step and at a moderate temperature, it has been found to be easier to carry out than conventional methods. In addition, it leads to smaller losses of metal, given that all of the metal contained in the precursor solution is deposited on the support grains. This advantage contributes in a notable manner to the reduction of costs, in particular during fabrication of materials based on noble metals such as ruthenium, rhodium, cobalt, platinum, palladium, nickel, . . . .

Regulation of the temperature and of the flow rate of the vector gas are adjusted in a manner such that the desired mass rate of metal with respect to the porous support is achieved.

Metallic or alloy nanoparticles are obtained by chemical decomposition of a precursor in the presence of a reactive gas, possibly thermally assisted. The precursor will be an inorganic or organometallic coordination complex. The following list, non-limiting, gathers several examples of precursors being able to being used:

Platinum:

[Pt₂(dba)₃]=Pt₂(C₁₇H₁₄0)₃

dba=dibenzylideneacetone=C₁₇H₁₄0

Name: tris(dibenzylideneacetone)diplatinum(0)

Palladium:

[Pd₂(dba)_{3]=Pd}₂(C₁₇H₁₄O)₃ 1)

dba=dibenzylideneacetone=C₁₇H₁₄0

Name: tris(dibenzylideneacetone)dipalladium(0)

[Pd(acac)₂]=[Pd(C₅H₇0₂)₂] 2)

acac=acetylacetonate=C₅H₇0₂

Name: bis(acetylacetonate)palladium(II)

Nickel:

[Ni (cod)₂]=[Ni(η⁴-C₈H₁₂)₂]

cod=1,5-cyclooctadiene=(η⁴-C₈H₁₂)

Name: bis(1,5-cyclooctadiene)nickel(0)

Cobalt:

[Co(η³-C₈H₁₃)(η⁴-C₈H₁₂]

η³-C₈H₁₃=1,3-cyclooctenyle

η⁴-C₈H₁₂=1,5-cyclooctadiene

Name: (1,3-cyclooctenyl)(1,5-cyclooctadiene)cobalt (I)

Iron:

[Fe(CO)₅]

Name: pentacarbonyl iron(0)

Ruthenium:

[Ru(cod)(cot)]=[Ru(η⁴-C₈H₁₂)(η⁶-C₈H₁₀]

cod=η⁴-C₈H₁₂=1,5-cyclooctadiene

cot=η⁶-C₈H₁₀=1,3,5-cyclooctatriene

Name: (1,5-cyclooctadiene)(1,3,5-cyclooctatriene)ruthenium(0)

Rhodium:

[Rh(acac)(cod)]=[Rh(C₅H₇0₂)(η⁴-C₈H₁₂)]

acac=acetylacetonate=C₅H₇0₂

cod=η⁴-C₈H₁₂=1,5-cyclooctadiene

Name: (1,5-cyclooctadiene)rhodium(I) acetylacetonate

Iridium:

[Ir(OMe)(cod)]₂=[Ir(OCH₃)(η⁴-C₈H₁₂)]₂

OMe=OCH₃=methoxy

cod=η⁴—C₈H₁₂=1,5-cyclooctadiene

Name: bis(methoxy)bis(1,5-cyclooctadiene)diiridium (I)

Copper:

[CuCp(^{t}BuNC)]=[Cu(C₅H₅)(C₅H₉N)]₂

Cp=C₅H₅=cyclopentadienyl

^{t}BuNC=C₅H₉N=tertbutylisonitrile

Name (cyclopentadienyl)(tertbutylisonitrile)copper(I)

Tin:

[Sn (NMe₂)₂]₂=Sn (N(CH₃)₂)₂]₂

NMe₂=N(CH₃)₂=dimethylamido

Name: bis(dimethylamidide)ditin (II)

Gold:

[AuCl(tht)]=[AuCl(C₄H₈S)]

tht=C₄H₈S=tetrahydrothiophene

Name: chloro(tetrahydrothiophene)gold(I)

Indium:

[InCp]=(In(C₅H₅)]

Cp=C₅H₅=cyclopentadienyl

Name: cyclopentadienyl indium (I)

Such precursors are chemically adsorbed on the support and are decomposed easily under the temperature and pressure conditions described above. The ligands that they have are then liberated and eliminated in the current of vector gas, the metal remaining fixed to the support. In the same manner, synthesis of bi- or polymetallic nanoparticles will be achieved starting from a mixture of complexes among these.

The duration of performance of the method is very much less than that of the conventional impregnation methods because it is carried out in the same apparatus (one-pot method). In the method of the invention, the duration of performance is adjustable as a function of the mass rate of metal with respect to the desired support.

When the installation of the method of the invention is gas tight and equipped with a vacuum pump, it permits the manipulation of precursors extremely sensitive to oxygen. The vector gas used is preferably constituted by a neutral gas, in particular nitrogen or argon, but the method can also function in air in order to permit the preparation of particles of metallic oxides under gentle conditions.

The porous support grains, the size of which is preferably comprised between 50 micrometers and 3 millimeters, can be constituted by any compound (generally inert) normally used as a catalyst support: activated charcoal, silica, alumina, titanium oxide, . . . .

The description that follows with reference to the attached drawing illustrates the method of the invention and furnishes examples of its use.

On the drawing, the single figure shows a diagram of an instillation by means of which the method according to the invention can be operated.

This installation is constituted by four distinct parts: the fluidized bed impregnation system; the liquid atomization system; the gas circuit and the sampling system.

The fluidized bed impregnation system is constituted by a cylindrical column 5 of stainless steel of 100 mm internal diameter and 500 mm height. At the outlet of the column, the gaseous effluents traverse a cyclone 7 intended to recover fine support particles entrained in the gaseous current. The distribution of the air at the base of the bed is assured with the aid of a perforated distributor plate, placed upstream of the column.

The liquid atomization system is disposed upstream of the impregnation system. The coating liquid is placed in two reservoirs 1,2, the one 1 that contains only the solvent for the starting of the installation and the other 2 that contains the metallic precursor solution. These two systems are connected to a peristaltic pump 3. Spraying of the liquid is assured by a bi-fluid pneumatic atomizer 6. The gas and the liquid are mixed at the interior. Atomizer 6 is furnished with a valve at the level of the liquid inlet. The opening and closing of the valve are directly controlled by a solenoid operated control valve (closing of the valve permits halting of the supply of liquid). Thus, it is easy to alternate the periods of spraying of the liquid and periods of halting supply.

The supply of gas to the column and the atomization system can be done in air or in a controlled atmosphere (nitrogen, dihydrogen, nitrogen/dihydrogen mixture). The fluidized gas passes through a preheater constituted by a tube heated by an electric oven 4. After passage into column 5, the gas containing the solvent vapors is condensed in an exchanger 7.

The system for sampling the solid is provided with an evacuation circuit 11 to eliminate the air in a withdrawal bottle 10 and a nitrogen circuit 12, which permits withdrawal at regular time intervals of samples sheltered from the air.

Temperature regulation within the fluidized bed is performed by fixing an assigned temperature means of a regulator that controls the heating power of electric oven 4. Temperature probes are placed at different levels of the bed, at the inlet of distributor 6 and at the outlet of oven 4. Differential membrane pressure sensors (inlet of distributor 6, lower and upper part of reactor 5) permit the evolution of the loss of the pressure within the bed to be followed.

The method of the invention can in particular be applied to prepare a nickel or palladium catalyst under the conditions hereafter set forth.

Use is made as a nickel source of bis(1,5-cyclooctadiene)nickel [Ni(η⁴-C₈H₁₂)₂]. The solution of [Ni(η⁴-C₈H₁₂)₂] in tetrahydrofuran (THF) is prepared in nitrogen. This solution is then sprayed on the support grains (microporous silica) placed in suspension by the vector gas (air or nitrogen) in the fluidized bed. After adsorption on the support, the precursor is decomposed. The bis(1,5-cyclooctadiene)nickel is decomposed at 80° C. for 5 hours.

The palladium precursors are the following coordination complexes: palladium bis(acetylacetonate) [Pd(C₅H₇0₂)₂] and dipalladium tris(dibenzylideneacetone) [Pd₂(C₁₇H₁₄O)₃]. The solution of each precursor in the THF is prepared in nitrogen. This solution is then sprayed on the support grains (microporous silica) placed in suspension by the vector gas (nitrogen) in the fluidized bed. After adsorption on the support, the precursor is decomposed. The palladium bis(acetylacetonate) and the dipalladium tris(dibenzylideneacetone) are treated in dihydrogen at 80° C. for 3 hours.

The invention extends to supported catalysts prepared by the method defined above. These catalysts constituted of porous support grains on which are dispersed particles of transition metals are characterized in that the metallic particles are of a nanometric size and well dispersed on the support grains.

The protocol for performance of the examples described hereafter is the following:

A predefined mass of metallic precursor in the form of powder is introduced in nitrogen into a flask preliminary purged with nitrogen. An adequate quantity of solvent, preliminarily distilled and degassed, is then added in nitrogen in a manner to obtain the metallic precursor solution.

Column 5 is loaded with a fixed mass of porous support grains through its upper part. Column 5 can be if needed purged of its air by being placed under a vacuum and sweeping with an inert gas. After closing of column 5, the fluidization gas at a fixed flow rate greater than 2.5 times the minimal speed of fluidization of the powders is introduced at the base of the column while being preliminarily heated. When the temperature of the bed has reached its assigned value, the atomization system is placed in operation. At the start, it is supplied with pure solvent. Then, when the thermal regime is reached, the system is supplied with the solution of metallic precursor.

During the course of impregnation, solid samples are withdrawn from the bed at regular time intervals.

Decomposition of the metallic precursor adsorbed on the support is then carried out in an atmosphere of dihydrogen or of a hydrogen/argon mixture.

The materials are then ready to be used.

### EXAMPLE 1 [Ni(cod)₂]=[Ni(η⁴-C₈H₁₂)₂] % Ni/SiO₂=0.1%

This example concerns the preparation of a material with 0.1% Ni/SiO₂ starting from the precursor Ni(η⁴-C₈H₁₂)₂]. The grains of the support are of microporous silica with a granulometry of 100-250μm, apparent density of 0.81 g/l, solid density of 2.08 g/l, microporosity of 47%, pour diameter of 70 angstroms and specific surface of 300 m²/g. The vector gas is nitrogen and the reducing gas dihydrogen. The different parameters are adjusted as follows:

Technical Details:

Support:

SiO₂

Mass of support (g)=257.6

Size of the particles of the support (μm)=100-200

Metallic precursor:

Ni(η⁴-C₈H₁₂)₂]

Mass of precursor (g)=1.4

Solvent=THF

Volume of solvent (ml)=500

Mass of the solvent (g)=440

Supplying of solvent:

Time (h)=1 h

Liquid flow rate (ml/min)=5, 7, 5 then 10

Gas=nitrogen

Fluidization flow rate (m³/h)=2

Impregnation:

Time of impregnation (min)=43

Liquid flow rate (ml/min)=10

Gas=nitrogen

Temperature of fluidized bed (° C.)=25

Fluidization flow rate (m³/h)=2

Decomposition

Reactor=fluidized bed

Gas=dihydrogen

Dihydrogen flow rate (m³/h)=3

Time (h)=4

Temperature (° C.)=80

### EXAMPLE 2 [Pd(dba)₂]=[Pd(C₁₇H₁₄O)₃] % Pd/SiO2=0.5%

This example concerns the preparation of a material with 0.5% Pd/SiO₂ starting from the precursor [Pd(C₁₇H₁₄O)₃]. The grains of the support are of microporous silica with a granulometry of 100-250 μm, apparent density of 0.81 g/l, solid density of 2.08 g/l, microporosity of 47%, pour diameter of 70 angstroms and specific surface of 300 m²/g. The vector gas is nitrogen and the reducing gas dihydrogen. The different parameters are adjusted as follows:

Technical Details:

Support:

SiO₂

Mass of support (g)=276.6

Size of the particles of the support (μm)=100-200

Metallic precursor:

[Pd(C₁₇H₁₄O)₃]

Mass of precursor (g)=6.45

Solvent=THF

Volume of solvent (ml)=1000

Mass of the solvent (g)=880

Supplying of solvent:

Time (h)=1 h 45 min.

Liquid flow rate (ml/min)=6, 8 then 10

Gas=nitrogen

Fluidization rate (m³/h)=2

Impregnation:

Time of impregnation (h)=1 h 40 min

Liquid flow rate (ml/min)=10

Gas=nitrogen

Temperature of fluidized bed (° C.)=25

Fluidization flow rate (m³/h)=2

Decomposition

Reactor=fluidized bed

Gas=dihydrogen

Dihydrogen flow rate ((m³/h)=3

Time (h)=5

Temperature (° C.)=80

### EXAMPLE 3 [Pd(acac)₂]=[Pd(C₅H₅O₂)₂] % Pd/Sio2=0.5%

This example concerns the preparation of a material with 0.5% Pd/Sio2 starting from the precursor [Pd(C₅H₅0₂)₂]. The grains of the support are of microporous silica with a granulometry of 100-250 μm, apparent density of 0.81 g/l, solid density of 2.08 g/l, microporosity of 47%, pour diameter of 70 angstroms and specific surface of 300 m²/g. The vector gas is nitrogen and the reducing gas dihydrogen. The different parameters are adjusted as follows:

Technical Details:

Support:

SiO₂

Mass of support (g)=253

Size of the particles of the support (μm)=100-200

Metallic precursor:

[Pd (C₅H₅0₂)₂]

Mass of precursor (g)=4.29

Solvent=THF

Volume of solvent (ml)=1000

Mass of the solvent (g)=880

Supplying of solvent:

Time (h)=1 h 30 min.

Liquid flow rate (ml/min)=6, 8 then 10

Gas=nitrogen

Fluidization rate (m³/h)=2

Impregnation:

Time of impregnation (h)=1 h 40 min.

Liquid flow rate (ml/min)=10

Gas=nitrogen

Temperature of fluidized bed (° C.)=25

Fluidization flow rate (m³/h)=2

Decomposition

Reactor=fluidized bed

Gas=dihydrogen

Dihydrogen flow rate ((m³/h)=3

Time (h)=3

Temperature (° C.)=80

Catalytic Tests:

Certain supported metallic nanoparticles described in this invention have been shown to be very active catalysts. Thus, the activities of SiO₂/Ni catalysts prepared by impregnation of the silica starting from the precursor Ni(cod)₂ at mass flow rates of Ni with respect to the silica of 0.5 and 0.1% have been evaluated. These materials have been tested in the hydrogenation reaction of hex-1-ene into hexane according to the following conditions:

substrate/catalyst Ratio=500

0.5 ml of 1-hexene in 5 ml of THf

reaction temperature=80° C.

duration of reaction=4 h

activity=T.F.(h⁻¹) number of moles of hexane/number of moles of metal/reaction time)

The rates of conversion of the hex-1-ene into hexane obtained for 0.5% and 0.1% SiO₂/Ni catalysts prepared in a fluidized bed are respectively 99 and 17% with, as respective activities, 111.3 h⁻¹ and 19.1 h^{-1.}

For comparison, a SiO₂/Ni catalyst having a nickel content of 5% was prepared from a Ni(NO₃)₂ precursor by impregnation in a fluidized bed. In this case, a treatment in dihydrogen at 500° C. is necessary to induce the formation of nickel metal. This catalyst led to, under the same operating conditions as those described previously, a conversion rate of hex-1-ene into hexane of 90% with an activity of 101.1 h⁻¹. Consequently, it appears that the catalyst prepared from the Ni(cod)₂ precursor is more efficient than that prepared from a Ni(NO₃)₂ precursor.

Similarly, palladium based catalysts prepared by impregnation of silica starting from Pd(acac)₂ and Pd(dba)₂ precursors with Pd with respect to the silica of 0.5 and 0.1% were evaluated by hydrogenation of hex-1-ene into hexane, under the same conditions as those previously described. The rates of conversion are in all cases 100%.

The present invention is not limited by the examples of realization given above by way of non-limiting examples. It concerns, to the contrary, all variations of realization within the capability of one skilled in the art in the framework of the claims herebelow.

1. Method for preparation of supported nanoparticles, characterized in that it has the following steps:
introduction into an adequate solvent of a metallic coordination complex able to be decomposed at a temperature below 200° C. with the possible presence of a reactive gas at a reactive gas pressure lower than 3 bars,
spraying of the preparation thus obtained under conditions suitable to avoid its decomposition in a fluidized bed containing porous support grains placed in suspension by a gaseous current, then
decomposition of the metallic coordination complex in the possible presence of a reactive gas.

2. Method according to claim 1, characterized in that the solvent is chosen in such a manner that the metallic coordination complex is soluble in said solvent.

3. Method according to one of claims 1 or 2, characterized in that the decomposition temperature of the metallic coordination complex is below 80° C.

4. Method according to claim 1, characterized in that the spraying of the preparation at the interior of the fluidized bed is a pneumatic spraying carried out by a current of vector gas.

5. Method according to claim 4, characterized in that the gas utilized for the pneumatic spraying is nitrogen or argon.

6. Method according to claim 5, characterized in that the reactive gas is selected from the group consisting of hydrogen (H₂) and carbon monoxide (CO).

7. Method according to claim 1, characterized in that two metallic coordination complexes are introduced in a solvent at the start of said method.

8. Method according to claim 1, characterized in that said method is carried out in a single apparatus.

9. Method according to claim 1, characterized in that said method is carried out continuously.

10. Method according to claim 1, characterized in that the metallic coordination complex is selected from the group consisting of:
tris(dibenzylideneacetone)diplatinum(0),
tris(dibenzylideneacetone)dipalladium(0),
bis(acetylacetonate)palladium(II),
bis(1,5-cyclooctadiene)nickel(0),
bis(acetylacetonate)nickel(II),
(1,3-cyclooctenyl)(1,5-cyclooctadiene)cobalt(I) pentacarbonyl iron(0),
(1,5-cyclooctadiene)(1,3,5-cyclooctatriene)ruthenium(0),
(acetylacetonate)(1,5-cyclooctadiene)rhodium(I),
bis(methoxy)bis(1,5-cyclooctadiene)diiridium(I),
(cyclopentadienyl)(tertbutylisonitrile)copper(I),
bis(dimethylamidide)ditin(II),
chloro(tetrahydrothiophene)gold(I), and
cyclopentadienyl indium(I).

11. Method according to claim 3, characterized in that the spraying of the preparation at the interior of the fluidized bed is a pneumatic spraying carried out by a current of vector gas.

12. Method according to claim 11, characterized in that the gas utilized for the pneumatic spraying is a neutral gas.

13. The method according to claim 12 wherein said neutral gas is nitrogen or argon.

14. Method according to claim 1, characterized in that the reactive gas is selected from the group consisting of hydrogen (H₂) and carbon monoxide (CO).

15. Method according to claim 14, characterized in that two metallic coordination complexes are introduced in a solvent at the start of said method.

16. Method according to claim 1, characterized in that said method is carried out continuously in a single apparatus.

17. Method according to claim 14, characterized in that the metallic coordination complex is selected from the non-exhaustive group consisting of:
tris(dibenzylideneacetone)diplatinum(0),
tris(dibenzylideneacetone)dipalladium(0),
bis(acetylacetonate)palladium(II),
bis(1,5-cyclooctadiene)nickel(0),
bis(acetylacetonate)nickel(II),
(1,3-cyclooctenyl)(1,5-cyclooctadiene)cobalt(I) pentacarbonyl iron(0),
(1,5-cyclooctadiene)(1,3,5-cyclooctatriene)ruthenium(0),
(acetylacetonate)(1,5-cyclooctadiene)rhodium(I),
bis(methoxy)bis(1,5-cyclooctadiene)diiridium(I),
(cyclopentadienyl)(tertbutylisonitrile)copper(I),
bis(dimethylamidide)ditin(II),
chloro(tetrahydrothiophene)gold(I), and
cyclopentadienyl indium(I).
